(19) United States
(12) Patent Application Publication
(10) Pub. No.: US 2012/0127650 A1
(43) Pub. Date: May 24, 2012

(54) SATA CONNECTOR AND DISK BOX ASSEMBLY

(75) Inventors: Hung-Chi Wang, Taipei (TW); Mei-Chuan Yang, Taipei (TW); Chin-Te Chiu, Taipei (TW)

(73) Assignee: CHENG UEI PRECISION INDUSTRY CO., LTD., Taipei (TW)

(21) Appl. No.: 12/949,026

(22) Filed: Nov. 18, 2010

(51) Int. Cl. G06F 1/16

(52) U.S. Cl. 361/679.33

(57) ABSTRACT

A SATA connector assembly has a SATA connector and a disk box mating with the SATA connector. The disk box has a main shell for accommodating a hard disk. The SATA connector has an insulating housing having a base. A pair of locking portions is located beside each lateral side of the base, the locking portion has an elastic arm with a contacting portion projected outwardly from a free end thereof. A pair of holding portions is protruded from an inner side of the main shell adjacent to two opposite sides of the opening for buckling with the locking portion to provide a steady connection between the disk box and the SATA connector.

### BACKGROUND OF THE INVENTION

1. Field of the Invention

The present invention relates to an electrical connector assembly, and more particularly to a SATA connector and disk box assembly.

2. The Related Art

Hard disks are now being designed to comply with a standard which is referred to as SATA standard. A conventional disk box includes a main shell, a hard disk accommodated in a receiving cavity of the main shell, and a cover covering the main shell. A front side of the hard disk forms an interface which has a plurality of contacts formed therein. A conventional SATA connector has an insulating housing, and a plurality of terminals mounted in the insulating housing configured to connect with contacts formed at the interface. The SATA connector is inserted to contact with the hard disk. However, it is difficult to judge whether the SATA connector is in the right place or not while the SATA connector is inserted into the hard disk. Also, the connection between the SATA connector and the hard disk is not steady.

### SUMMARY OF THE INVENTION

Accordingly, an object of the present invention is to provide a disk box mating with a SATA connector. The SATA connector has two locking portions at two opposite sides thereof, the locking portion has an elastic arm with a contacting portion projected outwardly from a free end thereof The disk box has a main shell, a hard disk accommodated in the main shell, and a cover covering the main shell. The main shell has a bottom wall and a plurality of side walls protruded upwardly from the bottom wall to define a receiving space thereamong for receiving the hard disk. An opening is defined at one of the side walls. A pair of holding portions is protruded from an inner side of the one side wall and adjacent to two opposite sides of the opening for buckling with the contacting portions of the locking portions. The hard disk has a side formed with an interface corresponding to the opening for mating with the SATA connector.

Another object of the present invention is to provide a SATA connector and disk box assembly. The assembly has a disk box and a SATA connector mating with the disk box. The disk box has a main shell, a hard disk accommodated in the main shell, and a cover covering the main shell. The main shell has a bottom wall and a plurality of side walls protruded upwardly from the bottom wall to define a receiving space thereamong for receiving the hard disk. An opening is defined at one of the side walls. A pair of holding portions is protruded from an inner side of the one side wall and adjacent to two opposite sides of the opening. The hard disk has a side formed with an interface corresponding to the opening. The SATA connector has an insulating housing having a base, a locking portion located beside each lateral side of the base, and a plurality of terminals mounted into the insulating housing. The locking portion has an elastic arm with a contacting portion projected outwardly from a free end thereof. The contacting portion of the locking portion buckles with the holding portion while the SATA connector is inserted into the interface of the disk box.

As described above, while the SATA connector is inserted to mate with the disk box, the contacting portion of locking portion touches the holding portion and further presses the holding portion until the locking portion buckles with the holding portion, such that users can judge whether the SATA connector is inserted into the right place or not, also, the SATA connector mates with the disk box in a firm manner which provides a steady connection between the SATA connector and the disk box.

### BRIEF DESCRIPTION OF THE DRAWINGS

The present invention will be apparent to those skilled in the art by reading the following description thereof, with reference to the attached drawings, in which:

FIG. 1 is an assembled, perspective view of a SATA connector and disk box assembly of an embodiment in accordance with the present invention;

FIG. 2 is an assembled, perspective view of the assembly shown in FIG. 1 without a cover;

FIG. 3 is an exploded, perspective view of the assembly shown in FIG. 1;

FIG. 4 is an exploded, perspective view of a main shell of a disk box of the assembly shown in FIG. 3;

FIG. 5 is a perspective view of a hard disk of the disk box shown in FIG. 3;

FIG. 6 is a perspective view, partly in cross-section, of the assembly, without the main shell and a cover of the disk box;

FIG. 7 is a part, perspective view showing a SATA connector located in the main shell of the disk box; and

FIG. 8 is a perspective view of an insulating housing of the SATA connector of a second embodiment in accordance with the present invention.

### DETAILED DESCRIPTION OF THE EMBODIMENT

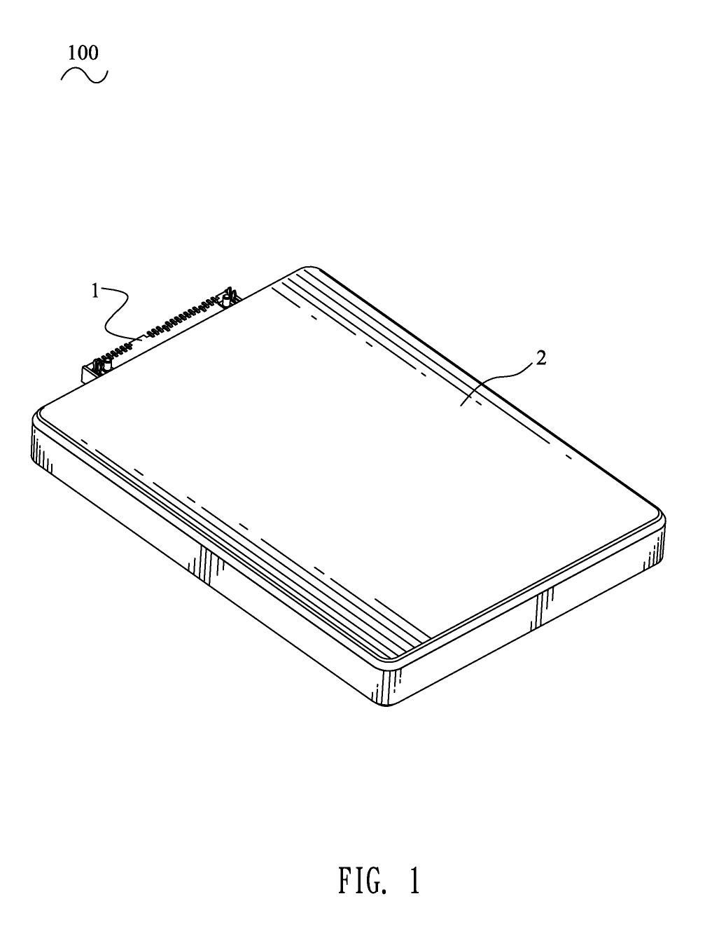

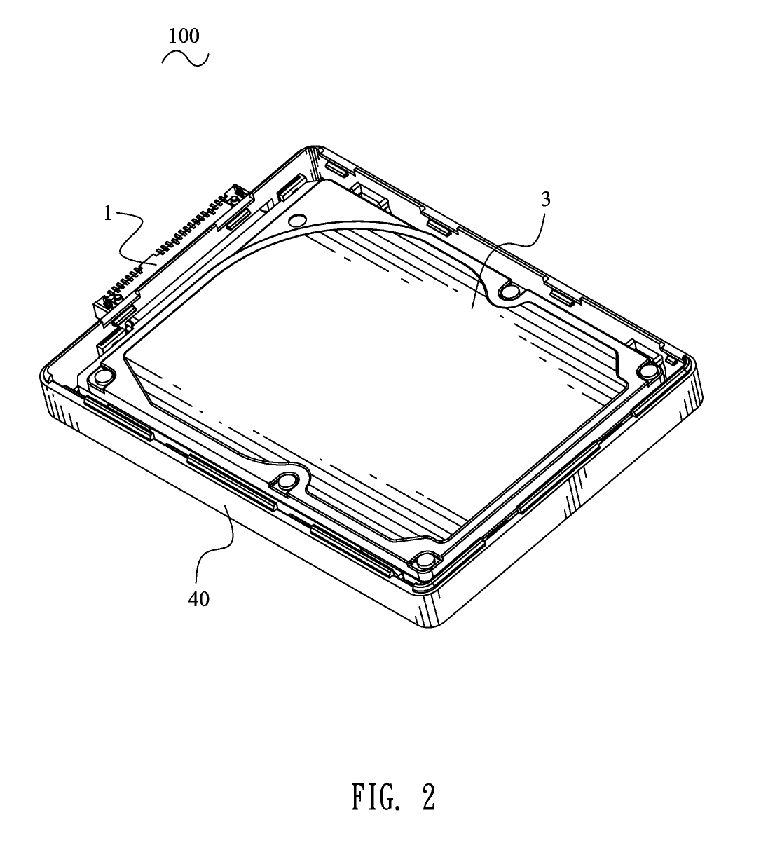

Referring to the drawings in greater detail, and first to FIGS. 1-3, the embodiment of the invention is embodied in a SATA connector and disk box assembly 100. The assembly 100 has a SATA connector 1 and a disk box 2 mating with the SATA connector 1. The SATA connector 1 has an insulating housing 10, a plurality of terminals 20 mounted into the insulating housing 10, and a pair of locking elements 30 fixing the insulating housing 10 on a board (not shown). The disk box 2 has a hard disk 3, a main shell 40 receiving the hard disk 3, and a cover 50 covering the main shell 40.

With reference to FIGS. 1-3, the insulating housing 10 has an oblong rectangular base 11. A front of the base 11 is recessed to form a pair of receiving slots 15 of inverted-L shape. A plurality of terminal grooves 14 is formed at the base 11 for receiving the terminals 20. A front of each lateral side of the base 11 is protruded to form a guide post 13. A pair of locking portions is disposed on the base 11 for providing a steady connection between the SATA connector 1 and the disk box 2.

In this embodiment, the locking portion has a rectangular locking block 12 and a locking element 30. The locking block 12 is protruded from a rear of the lateral side of the base 11. A bottom of the locking block 12 is recessed to form a receiving recess 121 extending frontward and rearwards and having a middle portion thereof extended upward and through a top of the locking block 12 to form a fixing recess 1211. The locking element 30 has a connecting slice 34 received in the receiving recess 121, and a base slice 31 extended upward from a rear of the connecting slice 34 and received in the fixing recess 1211. The connecting slice 34 connects with an elastic arm 35. A free end of the elastic arm 35 is arched sideward to form a contacting portion 36. A pair of fixing legs 32 is extended upward from a top of the base slice 31.

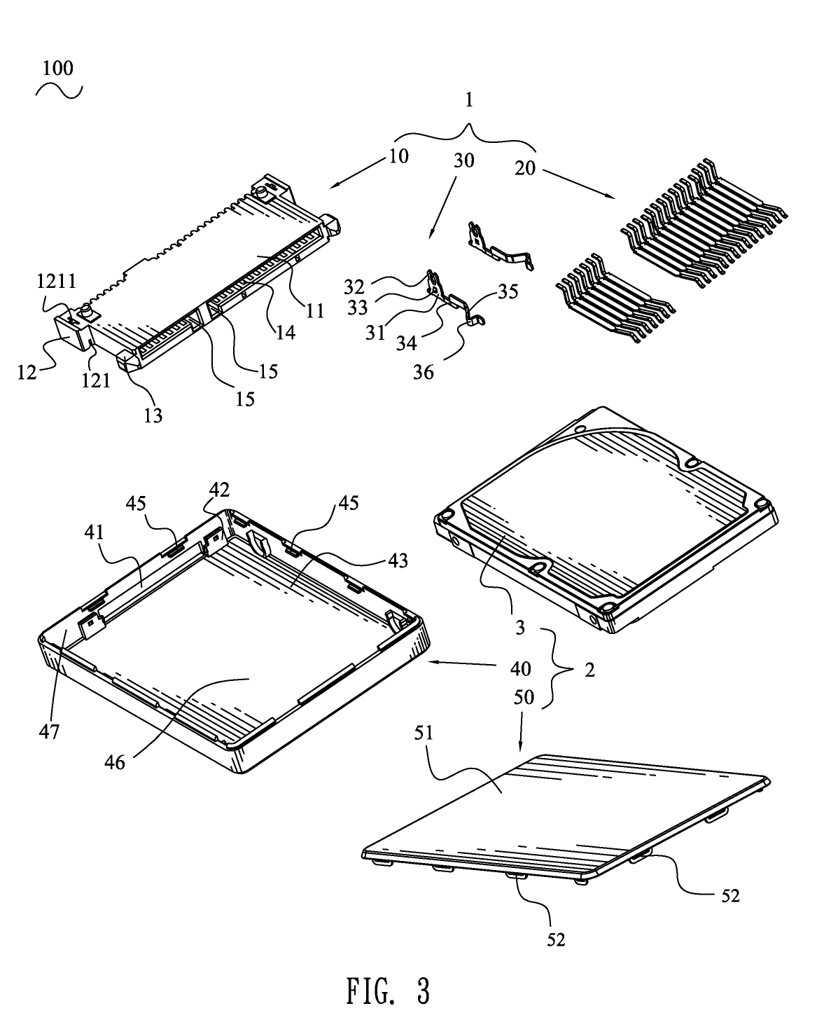

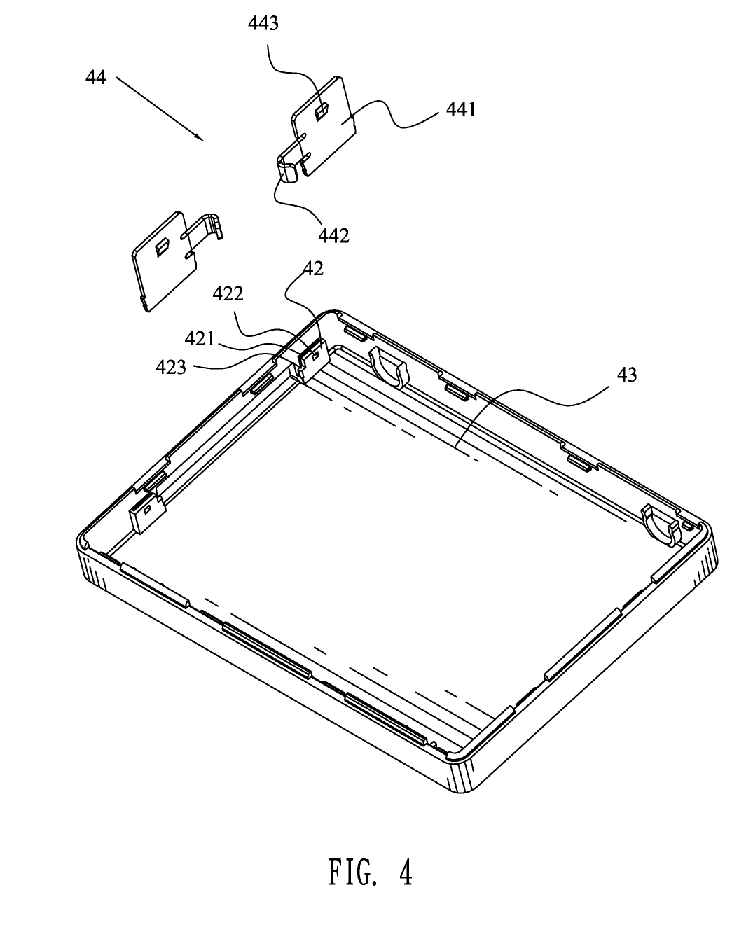

Please refer to FIGS. 3-4, the cover 50 has a flat plate 51. A bottom of the flat plate 51 is extended downward to form a plurality of fixing portions 52. The main shell 40 includes a bottom wall 46 and a plurality of side walls 47 protruded upwardly from the bottom wall 47 to define a receiving space 43 thereamong for receiving the hard disk 3. A plurality of bumps 45 is extended inward from the side walls 47 of the main shell 40 mating with the corresponding fixing portions 52 for fixing the cover 50 on the main shell 40. The main shell 40 has an opening 41 at a substantially middle portion of one of the side walls 47. Beside two opposite ends of the opening 41, a pair of holding portions 42 is protruded inward from an inner side of the one side wall 47. An inner side of the holding portion 42 is recessed to form a holding recess 421 for receiving a shielding plate 44. A side of the holding recess 421 defines a fixing opening 422. A lateral side of the holding portion 42 adjacent to the opening 41 is protruded to form a holding bump 423. The shielding plate 44 has a rectangular base plate 441 having a lateral side extended to form a clasping arm 442 having a curved free end. A barb 443 is protruded from a lateral side of the base plate 441.

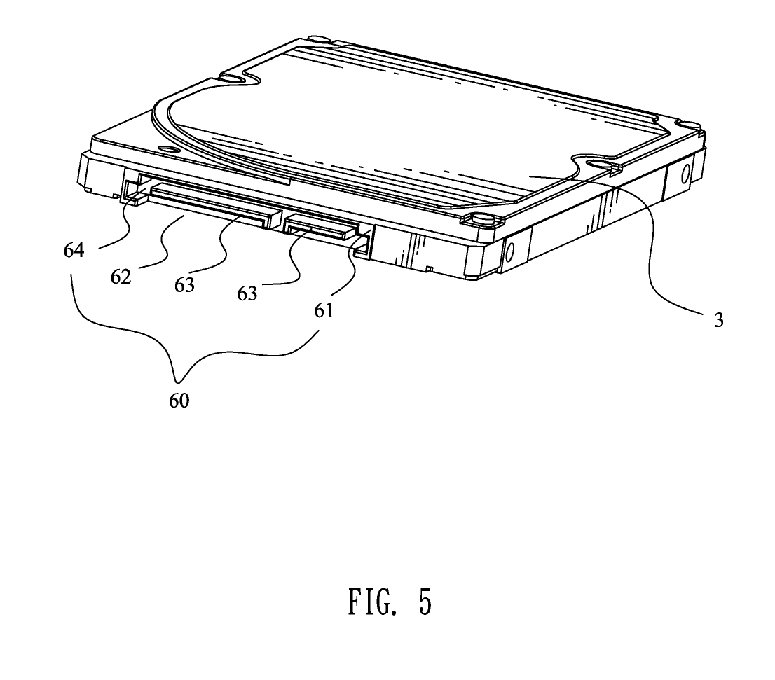

Referring to FIG. 5, the hard disk 3 has a front side formed with an interface 60. The interface 60 forms a receiving cavity 62 for the receipt of the SATA connector 1 around two tongues 63 of inverted-L shape. Each of two opposite sides of the receiving cavity 62 defines a guide recess 64 communicating with the receiving cavity 62. The guide recesses 64 aid in guiding the SATA connector 1 to mate with the disk box 2.

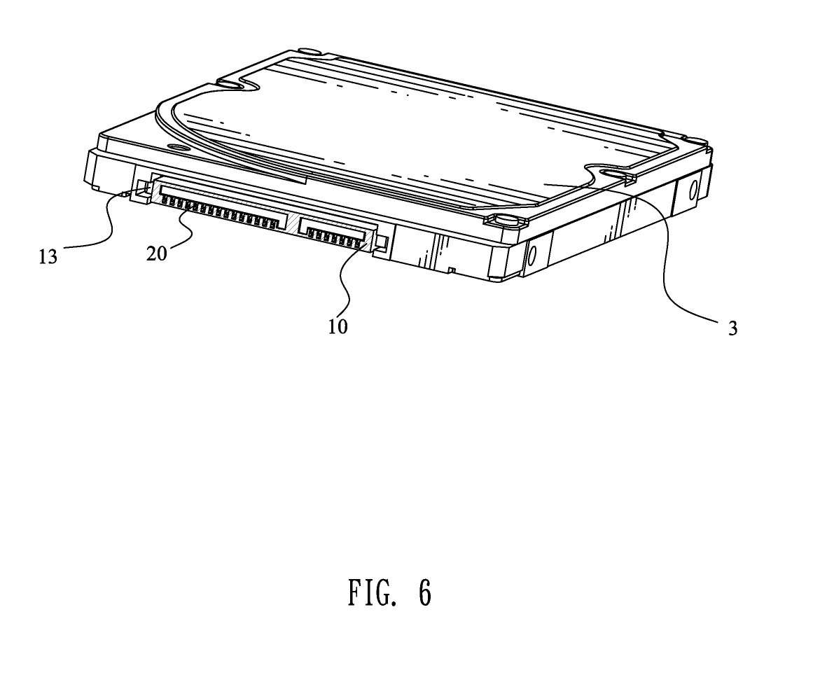

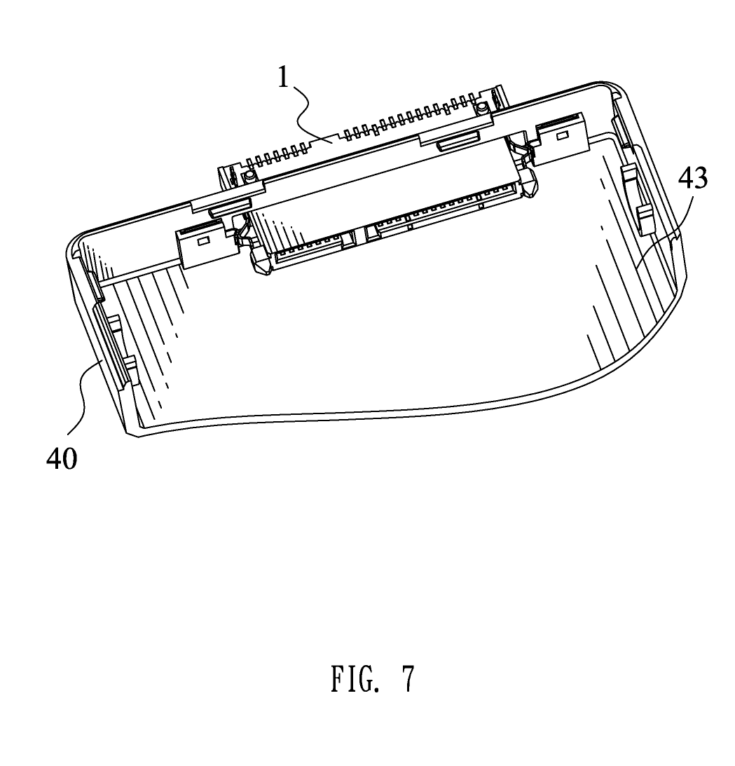

Referring to FIGS. 3-7, in assembly, the shielding plate 44 is fixed into the holding recess 421 of the main shell 40 by means of the barb 443 buckling with the fixing opening 422. The curved free end of the clasping arm 442 of the shielding plate 44 wraps the holding bump 423 for protecting the holding bump 423 from abrasion while the SATA connector 1 is inserted into the interface 60 of the hard disk 3. The locking element 30 is fixed into the locking block 12 with the connecting slice 34 received in the receiving recess 121, the fixing leg 32 stretching out of the fixing recess 1211 for fixing the insulating housing 10 on the board (not shown), the elastic arm 35 stretching frontward out of the receiving recess 121. While the SATA connector 1 is inserted to mate with the disk box 2, the tongue 63 is received into the corresponding guide slot 15, along with the guide post 13 into the guide recess 64, so the SATA connector 1 mates with the disk box 2 in an aligned and firm manner such that the common problem associated with the breakage of the connector is avoided. The contacting portion 36 touches the clasping arm 442 and further presses the clasping arm 442 until the contacting portion 36 buckles with the clasping arm 442.

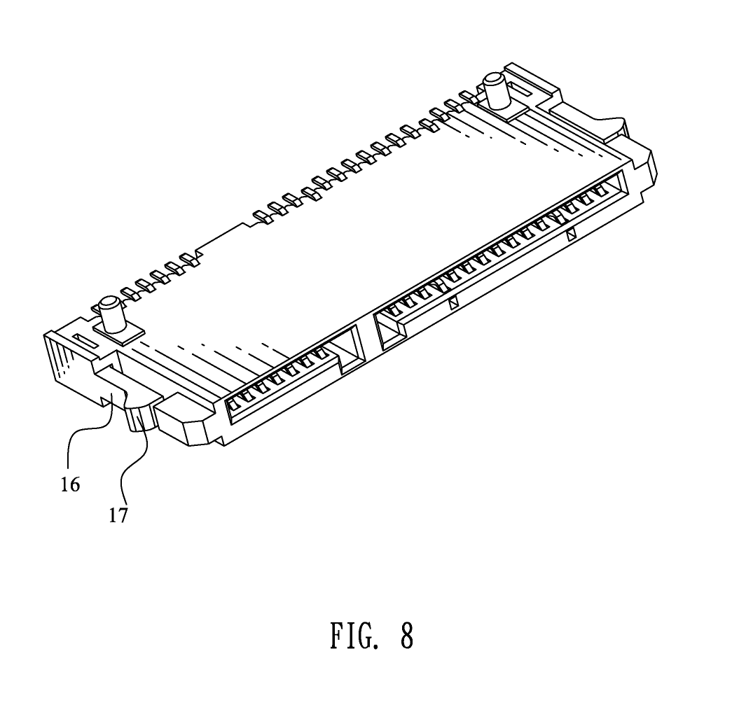

Further, referring to FIG. 8, the locking element 30 may be in shape of a plastic elastic arm 16 integrally molded with each lateral side of the base 11 having a contacting portion 17 projected outward from a front free end thereof for buckling with the corresponding clasping arm 442.

As described above, while the SATA connector 1 is mated with the disk box 3, the contacting portion 36, 17 touches the clasping arm 442 and further presses the clasping arm 442 until the contacting portion 36, 17 buckles with the clasping arm 442, such that users can judge whether the SATA connector 1 is inserted into the right place or not, also, the SATA connector 1 mates with the disk box 2 in a firm manner, which provides a steady connection between the SATA connector 1 and the disk box 2.

What is claimed is:

1. A disk box mating with a SATA connector, the SATA connector having two locking portions at two opposite sides thereof, the locking portion including an elastic arm with a contacting portion projected outwardly from a free end thereof, the disk box comprising:
a main shell having a bottom wall and a plurality of side walls protruded upwardly from the bottom wall to define a receiving space thereamong, an opening defined at one of the side walls, a pair of holding portions protruded from an inner side of the one side wall and adjacent to two opposite sides of the opening for buckling with the contacting portions of the locking portions;
a cover covering the receiving space; and
a hard disk accommodated in the receiving space having a side formed with an interface corresponding to the opening for mating with the SATA connector.

2. The disk box as claimed in claim 1, further comprising a shielding plate, the shielding plate including a base plate received in the holding recess defined in the holding portion and a clasping arm extended from the base plate having a curved free end wrapping one end of the holding portion adjacent to the opening for buckling with the contacting portion of the locking portion.

3. A SATA connector and disk box assembly, comprising:
a disk box having
a main shell having a bottom wall and a plurality of side walls protruded upwardly from the bottom wall to define a receiving space thereamong, an opening defined at one of the side walls, a pair of holding portions protruded from an inner side of the one side wall and adjacent to two opposite sides of the opening,
a cover covering the receiving space, and
a hard disk accommodated in the receiving space having a side formed with an interface corresponding to the opening; and
a SATA connector mating with the disk box having
an insulating housing having a base,
a locking portion located beside each lateral side of the base, the locking portion including an elastic arm with a contacting portion projected outwardly from a free end thereof, and
a plurality of terminals mounted into the insulating housing,
wherein the contacting portion of the locking portion buckles with the holding portion while the SATA connector is inserted into the interface of the disk box.

4. The SATA connector assembly as claimed in claim 3, further comprising a shielding plate, the shielding plate including a base plate received in the holding recess defined in the holding portion and a clasping arm extended from the base plate having a curved free end wrapping one end of the holding portion adjacent to the opening for buckling with the contacting portion of the locking portion.

5. The SATA connector assembly as claimed in claim 3, wherein the locking portion includes two locking blocks extended outward from rears of two lateral sides of the base and a pair of locking elements, a bottom of the locking block is recessed to form a receiving recess having a middle portion extended upward to form a fixing recess, the locking element has a base slice, a connecting slice extended from the base slice and received in the receiving recess, a pair of fixing legs extended from a top of the base slice and stretching out of the fixing recess, the elastic arm is extended from the connecting slice having the contacting portion arched outward and stretching frontward out of the receiving recess for buckling with the holding portion.

6. The SATA connector assembly as claimed in claim 3, wherein the elastic arm is plastic and molded with the insulating housing, the contacting portion shows an arched bump for buckling with the holding portion.
